(19) United States
(12) Patent Application Publication
(10) Pub. No.: US 2006/0216623 A1
(43) Pub. Date: Sep. 28, 2006

(54) Polycondensation promoter, dispersion of fine resin particles and method for manufacturing the same, electrostatic charge image developing toner and method for manufacturing the same

(75) Inventors: Yasuo Matsumura, Minamiashigara-shi (JP); Hirotaka Matsuoka, Minamiashigara-shi (JP); Hideo Maehata, Minamiashigara-shi (JP); Satoshi Hiraoka, Minamiashigara-shi (JP); Yuki Sasaki, Minamiashigara-shi (JP); Fumiaki Mera, Minamiashigara-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/175,273

(22) Filed: Jul. 7, 2005

(30) Foreign Application Priority Data
Mar. 24, 2005 (JP) 2005-087292

(51) Int. Cl. G03G 9/08

(52) U.S. Cl. 430/108.1; 430/137.1; 528/275

(57) ABSTRACT

The method for manufacturing of dispersion of fine resin particles of the present invention first emulsifies or disperses a polycondensable monomer for purposed fine resin particles into an aqueous medium. At this time, additives, such as a catalyst, a surfactant, and the like, are also added into the water soluble medium, as required. By subjecting this solution to, for example, heat, or the like, polycondensation proceeds. In this polycondensation, a strong acid salt is used as a polycondensation promoter. In addition, by using the obtained dispersion of fine resin particles, an electrostatic charge image developing toner is manufactured.

### CROSS-REHERENCE TO RELATED APPLICATION

This application claims priority under 35USC 119 from Japanese Patent Application No. 2005-087292, disclosure of which is incorporated by reference herein.

### BACKGROUND OF THE INVENTION

1. Field of the Invention

The present invention relates to an electrostatic charge image developing toner which is used in developing an electrostatic latent image formed by anelectrophotographic method, an electrostatic recording method, or the like, with the use of a developer, and a method for manufacturing the same, as well as a dispersion of fine resin particles that is used as the raw material therefor. In addition, the present invention relates to a polycondensation promoter which is used in manufacturing the dispersion of fine resin particles.

2. Description of the Related Art

As means for manufacturing the toner, toner manufacturing methods based on emulsification, polymerization, and aggregation have been disclosed in Japanese Patent Application Laid-Open (JP-A) Nos. 63-282752 and 6-250439. These methods generally prepare a dispersion of resin by emulsification and polymerization, and on the other hand, prepare a dispersion of a coloring agent that disperses the coloring agent into a solvent. Then, these are mixed for formation of aggregates having a size equivalent to the toner particle diameter, and the aggregates are heated to be fused and coalesced, to produce a toner.

When toner manufacture is conducted by the emulsification, polymerization, and aggregation method as described above, the polymerization type crystalline resin is polymerized, which is followed by emulsifying it in water to produce a latex, and aggregating the latex particles together with a pigment and a wax to enable fusion and coalescence.

However, this method requires an extremely inefficient and high-energy consuming process, such as emulsifying the polymerization resin with a high shearing force at a temperature as high as over 150° C. or dissolving it into a solvent to disperse a solution having a decreased viscosity in water before then removing the solvent.

In addition, in emulsification into the water, it is difficult to avoid problems such as hydrolysis, and in the material design, occurrence of contingency factors has been unavoidable.

Incidentally, it has been reported that the polymerization of a polyester in an aqueous medium, which has conventionally been considered to be difficult, can be performed in an aqueous medium (U.S. Pat. No. 4,355,154). This report discloses that a polyester is polymerized in an aqueous medium in the presence of a catalyst having a sulfonic acid group.

### SUMMARY OF THE INVENTION

If, by utilizing the method for manufacturing a polycondensation resin in an aqueous medium, as disclosed in the above report, polycondensed fine resin particles can be formed in an aqueous medium, the need for separately emulsifying the polycondensed fine resin particles into an aqueous medium is eliminated, which is considered to be extremely advantageous.

However, with the method for polycondensation of a polyester in an aqueous medium that has been previously reported, there are many unknown points about the polymerization mechanism, and when the method for polycondensing a polyester in an aqueous medium is applied to manufacture of a polyester for toner, the art as disclosed in that literature alone cannot solve such big problems with manufacturing and the properties as that it will not allow the particle dispersion in the aqueous medium after the polymerization, and the stability of the emulsion to be sufficiently achieved, and further it will not provide a molecular weight for achieving a sufficient image quality required of the toner. In addition, the particle diameter distribution of the resin, the charging characteristics, and the environmental dependency of charging are insufficient, and the image quality characteristics, and the image quality reliability are extremely low at present.

A first aspect of the present invention is to provide a polycondensation promoter comprising a strong acid salt.

A second aspect of the present invention is to provide a method for manufacturing of dispersion of fine resin particles comprising: emulsifying or dispersing a polycondensable monomer in an aqueous medium; and polycondensing the polycondensable monomer in the aqueous medium; wherein, In the polycondensation, a polycondensation catalyst, and a polycondensation promoter comprising a strong acid salt are used for carrying out a polycondensation reaction.

A third aspect of the present invention is to provide a dispersion of fine resin particles with which the fine resin particles are dispersed into an aqueous medium, wherein said fine resin particles contain a polycondensation promoter comprising a strong acid salt.

A fourth aspect of the present invention is to provide a method for manufacturing of electrostatic charge image developing toner that uses a dispersion of fine resin particles dispersing fine resin particles containing a polycondensation promoter comprising a strong acid salt in an aqueous medium, aggregates the fine resin particles in the dispersion of fine resin particles, and then heats them for fusion.

A fifth aspect of the present invention is to provide an electrostatic charge image developing toner having a strong acid salt.

### DETAILED DESCRIPTION OF THE INVENTION

(Dispersion of Fine Resin Particles)

Hereinafter, the method for manufacturing the dispersion of fine resin particles of the present invention will be described in detail together with the polycondensation promoter of the present invention.

The method for manufacturing the fine resin particles of the present invention first emulsifies or disperses a polycondensable monomer as the raw material for the purposed fine resin particles into an aqueous medium by using, for example, mechanical shearing force, ultrasonic wave, or the like. In this case, additives, such as a catalyst, a surfactant, and the like, are also added into the water-soluble medium as required. To this solution, heat or the like, for example, is applied to progress the polycondensation. Further, as a catalyst to be used in this polycondensation, a polycondensation promoter is used in combination with the polycondensation catalyst.

Generally, because the polycondensable resin involves dehydration in polymerization, the reaction will not theoretically proceed in water. However, when the polycondensable monomer is emulsified or dispersed into an aqueous medium together with a surfactant which can form a micelle (oil phase), the monomer is placed in the micro hydrophobic field in the micelle, which causes a dehydration action to occur, and thus the generated water to be discharged into the aqueous medium outside the micelle, which allows the polymerization to be progressed. Thus, a emulsified-dispersion in which the polycondensed fine resin particles have been emulsifying-dispersed into an aqueous medium with low energy is obtained.

However, for polycondensation of the polycondensable monomer in an aqueous medium, use of a surfactant type polycondensation catalyst, a hydrolysis enzyme, or a rare-earth containing catalyst is known, but it has been found that, in this case, the polycondensation catalyst is concentrated on the surface boundary of the micelle, and thus in the inside of the micelle, the polycondensation reaction is made difficult to be progressed. Therefore, a part of the low molecular-weight component tends to be resided after the polymerization. Then, in the present invention, a strong acid salt is used as a polycondensation promoter together with the above-mentioned polycondensation catalyst for progressing the polycondensation inside the micelle. The cause for such a progress is considered to be that the strong acid salt reaches the inside of the micelle, allowing the polycondensation to be progressed. Particularly, the strong acid salt exists as a solid when mixed with the polycondensable monomer, and at least at the initial stage of the polymerization, exists in the polycondensable monomer as a non-uniform solid, thereafter, being capable of exerting the catalytic effect also when it is dissolved in the monomer during the polycondensation or dissolved in the water. For such a reason, it is preferable that the strong acid salt be contained in the polycondensable monomer as the polycondensation promoter, and exist as a solid when mixed with the polycondensable monomer. That the strong acid salt exists as a solid in the polycondensable monomer can be identified by the polycondensable monomer solution becoming cloudy with the addition of the strong acid salt. Thereby, with an increase in the molecular weight of the fine resin particles obtained by the present invention, the particle size distribution therefor is sharpened. In addition, although the reason for it is not clear, the number-average molecular weight of the fine resin particles obtained is increased with an increase in the weight-average molecular weight.

In addition, by using the strong acid salt as the polycondensation promoter in combination with the polycondensation catalyst, the stability of the emulsification/dispersion of the fine resin particles can be improved. The reason for it is considered to be that the amount of the low molecular-weight component in the fine resin particles is decreased with the number-average molecular weight being increased, resulting in the adhesiveness of the particle surface in the water being lowered.

When the dispersion of fine resin particles obtained by such a manufacturing method is applied to the method for manufacturing electrostatic charged image developing toner, the strength and particle size distribution as a toner are improved, and in addition, the composition and structure of the individual toner are made uniform, thus an electrostatic charged image developing toner which sufficiently meets the requirements for toner characteristics is obtained.

Next, the strong acid salt which is the polycondensation promoter of the present invention will be described. The polycondensation promoter means a catalyst to be used in combination with the polycondensation catalyst.

Preferable examples of the strong acid salt include strong acid salts which contain at least one type of element selected from silicon, aluminum, phosphorus, molybdenum, tungsten, cesium, niobium, titanium, tin, silver, copper, zinc, chromium, tellurium, antimony, bismuth, selenium, zirconium, iron, magnesium, calcium, vanadium, cerium, manganese, cobalt, iodine, and nickel.

Specifically, preferable examples of the strong acid salt include zeolites, solid superacids, heteropoly acids, metal oxides, and the like.

A zeolite is a porous, crystalline aluminosilicate, exhibiting a strong proton acidity. Depending upon the crystal structure, A type, X type, Y type, faujasite type, mordenite type, ZSM-5 type, and the like are available, and any of these can be used as powder or a molded item. However, the ZSM-5 type, and further among these, that with which the counter ion is a hydrogen ion is particularly preferable.

As the solid superacid, sulfated zirconia, zirconia tungstate, tungstosilisic acid, zirconia molybdate, and the like are preferable, because they are solids, and can effectively progress dehydration-polycondensation.

The heteropoly acid is a generic term of acids which are generated by two or more different oxygen acids undergoing dehydration condensation. For example, when a phosphate ion and a tungstate ion are allowed to react with each other in an acidic condition, they are condensed as expressed in the following formula, forming 12-tungstophosphoric acid, which is a typical heteropoly acid, to provide an extremely effective compound for acid catalytic reaction.
Formula: PO₄³⁻+12WO₄²⁻+27H⁺→H₃PW₁₂O₄₀+12H₂O

Herein, as the hetero atom which is equivalent to P in the formula, a number of atoms of elements ranging from group I to group VIII can be used. As the poly atom equivalent to W, molybdenum, tungsten, niobium, vanadium, and the like can be used. Examples of the hetero atom include phosphorus, arsenic, silicon, germanium, cerium, thorium, manganese, nickel, tellurium, iodine, cobalt, chloride, selenium, and the like.

A variety of examples of the metal oxide which can be used include tin oxide, titanium oxide, alumina, magnesia, copper oxide, vanadium oxide, zinc oxide, germanium oxide, niobium oxide, nickel oxide, antimony oxide, manganese oxide, cobalt oxide, gallium oxide, zirconia, compounds which are produced by causing the surface of these metal oxides to carry a sulfate ion and calcining them at high temperature for binding, and the like, and further composites of these oxides may be used.

Among these strong acid salts, it is preferable to select at least one type from zeolite, sulfated zirconia, zirconia tungstate, tungstosilisic acid, zirconia molybdate, and heteropoly acid, because these have a high catalytic capability.

In addition, it is preferable that the strong acid salt be atomized in order to cause it to reach the inside of the micelle (oil phase) in an aqueous medium, and effectively exert the function as a catalyst. The particle diameter for such an atomized strong acid salt is preferably 0.01 to 10.0 μm in volume-average particle diameter, more preferably 0.03 to 2.0 μm, and still more preferably 0.05 to 0.5 μm. The definition of this volume-average particle diameter is the same as that of the volume-average particle diameter for fine resin particles.

Herein, the term “strong acid” refers to an acid having a high acid strength, the value being −10.0 or less in terms of the Hammet acidity function (Ho). Among the strong acids, the acids particularly having an acid strength of Ho<−11.93, i.e., being stronger than 100% sulfuric acid, is referred to as an superacid. In the present invention, the term “strong acid” means “strong acid” including “superacid”.

ZSM-5, which is a type of zeolite, sulfated zirconia, Cs-substituted heteropoly acid (Cs_{2.5}H_{0.5}PW₁₂O₄₀), and the like are in the region of solid superacid, but about the mechanism of development of the superacidity, the structure of the active center, and the like, there are a number of uncertain points. It is considered that the development of the strong acidity of sulfated zirconia is attributed to the strong electron attracting property of the sulfate ion.

The Hammet acidity function (Ho) for a particular strong acid salt can be determined as follows. The base B having no electric charge that exhibits the Brφnsted acid-base behavior binds to a hydrogen ion as expressed in the following formula in the aqueous solution.
B+H⁺ [symbol] B H
and assuming that the dissociation equilibrium constant for BH⁺ is pK_{BH+}, the percentage at which B binds to H⁺ when placed in a specific solvent is C_{BH+}, and the percentage at which B does not bind is C_{B}, the Hammet acidity function (Ho) can be expressed by the following equation:
Ho=pK_{BH+}−log(C_{BH+}/C_{B})

The actual measurement is performed as follows. 0.3 g of a powdered and atomized strong acid salt catalyst sample is mixed with 20 ml of a cyclohexane solvent in a 50-ml stoppered flask, and after allowing to stand for 15 hours, one drop of a 1 mole solution of cyclohexane, which is an indicator for determining the acid strength, is added for observation of the coloration. Thereby, the strongest acid strength of the strong acid salt catalyst sample can be determined, and the measurement is used as the Ho. In the case of an acid, it is known that the acid has an acid strength distribution, however, the Hammet acidity function (acid strength) Ho herein expresses the strongest acid strength. Indicators which can be used include p-dimethylamino azobenzene (pK_{BH+}3.3), phenyl azodiphenylamine (pK_{BH+}1.5), benzylydeneacetophenon (pK_{BH+}−5.6), anthraquinone (pK_{BH+}−8.2), nitrofluorobenzene (pK_{BH+}−12.4), dinitrobenzene (pK_{BH+}−14.5), and the like. For details, existing books, such as “New Experimental Chemistry Course” (Maruzen), and the like, can be referenced.

Next, the polycondensation catalyst will be described. The polycondensation catalyst is a catalyst which is used for polycondensing a polycondensable monomer at a low temperature. Preferable examples of such a polycondensation catalyst having a catalytic activity at low temperature include surfactant-type catalysts, rare-earth containing catalysts, or hydrolysis enzymes. Use of these catalysts can cause polycondensation at a temperature of 100° C. or below in an aqueous medium, for example. In order to progress the polycondensation at higher speed, or in order to allow a wider range of monomers to be used, the polycondensation may be progressed in an aqueous medium heated to above 100° C.

As the surfactant-type catalyst, acids giving a surface-active effect can be exemplarily mentioned. The acid giving a surface-active effect has a chemical structure which has a hydrophobic group and a hydrophilic group in which at least a part of the hydrophilic group has a structure of an acid with protons, and provides both functions of emulsification and catalysis.

Examples of the acids having a surface-active effect include alkylbenzensulfonic acids, such as dodecylbenzensulfonic acid, isopropylbenzensulfonic acid, allylbenzensulfonic acid, camphor sulfonic acid, and the like; alkylsulfonic acid, alkyldisulfonic acid, alkylphenolsulfonic acid, alkylnaphthalinesulfonic acid, alkyltetralinsulfonic acid, alkylallylsulfonic acid, petroleum sulfonic acid, alkylbenzoimidazolsulfonic acids, higher alcoholether sulfonic acid, alkyldiphenolsulfonic acid, monobutylphenylphenol sulfuric acid, dibutylphenylphenol sulfuric acid, dodecyl sulfuric acid, as typical of higher fatty acid sulfuric acid esters, higher alcohol sulfuric acid ester, higher alcohol ether sulfuric acid ester, higher fatty acid amidealkylol sulfuric acid ester, higher fatty acid amide alkylated sulfuric acid ester, naphthenylalcohol sulfuric acid, sulfated fat, sulfosuccinic acid ester, various fatty acids, sulfonated higher fatty acid, higher alkyl phosphoester, resin acid, naphthenic acid thereof, and salt compounds of all of these, and the like. A plurality of these compounds may be used in combination as required.

As the rare-earth containing catalyst, those which contain, as the lanthanoid element, lanthanum (La), cerium (Ce), praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), ytterbium (Yb), lutetium (Lu), and the like are effective. Particularly, those which have alkylbenzenesulfonate, alkyl sulfuric acid ester salt, or a triflate structure, and the like, are effective. The metal triflate is preferably a compound expressed by a structural formula of X(OSO₂CF₃)₃X. In this formula, X denotes scandium (Sc), yttrium (Y), ytterbium (Yb), samarium (Sm), or the like.

In addition, as the rare-earth containing catalyst, lanthanoid triflate, and the like are also preferable. About lanthanoid triflate, a detailed description is given in Journal of Synthetic Organic Chemical Society, vol. 53, No. 5, pp 44 to 54.

The hydrolysis enzyme to be used is not particularly limited, provided that it catalyzes the ester synthesizing reaction. Examples of the hydrolysis enzyme include esterases classified into the group EC (enzyme code number) 3.1 (as given in “Enzyme Handbook” supervised by Maruo and Tamiya, Asakura Shoten, 1982, and other books), such as carboxyesterase, lipase, phospholipase, acetylesterase, pectinesterase, cholesterolesterase, tannase, monoacylglycerollipase, lactonase, lipoproteinlipase, and the like; hydrolysis enzymes acting on glycosyl compounds that are classified into the group EC 3.2, such as glucosidase, galactosidase, glucuronidase, xylosidase, and the like; hydrolysis enzymes classified into the group EC 3.3, such as epoxidehydrase; hydrolysis enzymes acting on peptide bonds that are classified into the group EC 3.4, such as aminopeptidase, chymotrypsin, trypsin, plasmin, subtilisin, and the like; hydrolysis enzymes classified into the group EC 3.7, such as phloretin-hydrase, and the like; and the like.

Among these esterases, the enzymes which hydrolyse glycerol esters to release fatty acids are particularly called the lypases, and the lypases offer such advantages as those that they are highly stable in organic solvents, catalyze the ester synthesizing reaction with a good yield, and further are available at low cost. Therefore, also with the polyester manufacturing method of the present invention, it is preferable to use the lypase from the viewpoints of yield and cost.

As the lypase, those which are derived from various sources can be used, however, preferable examples include lypases obtained from microorganisms of the genus Pseudomonas, the genus Alcaligenes, the genus Achromobacter, the genus Candida, the genus Aspergillus, the genus Rhizopus, the genus Mucor, and the like; lypases obtained from the seeds of plants; lypases obtained from the tissue of animals; further, pancreatin, steapsin, and the like. Among these, the lypases obtained from microorganisms of the genus Pseudomonas, the genus Candida, and the genus Aspergillus are preferably used.

These polycondensation catalysts may be used alone or in combination of two or more different types.

Next, the polycondensable monomers and the fine resin particles obtained by polycondensation thereof will be described. Examples of the polycondensable monomer to be used for polycondensation include multivalent carboxylic acids, polyols, polyamines, and the like. Particularly, as the polycondensable monomer, it is preferable to use that which contains a multivalent carboxylic acid and a polyol, for obtaining a polyester.

The multivalent carboxylic acid refers to a compound which contains two or more carboxylic groups in one molecule. Among the multivalent carboxylic acids, the bivalent carboxylic acid is a compound which contains two carboxylic groups in one molecule, and examples thereof include oxalic acid, succinic acid, maleic acid, adipic acid, β-methyladipic acid, azelaic acid, sebacic acid, nonandicarboxylic acid, decandicarboxylic acid, undecandicarboxylic acid, dodecandicarboxylic acid, fumaric acid, citraconic acid, diglycol acid, cyclohexane 3,5-dien-1,2-carboxylic acid, malic acid, citric acid, hexahydroterephthalic acid, malonic acid, pimelic acid, tartaric acid, mucic acid, phthalic acid, isophthalic acid, terephthalic acid, tetrachlorphthalic acid, chlorphthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p-dicarboxylic acid, naphthalene-1,4-dicarboxylic acid, naphthalene-1,5-dicarboxylic acid, naphthalene-2,6-dicarboxylic acid, anthracenedicarboxylic acid, and the like. In addition, as the multivalent carboxylic acids other than the bivalent carboxylic acid, examples thereof include trimellitic acid, pyrromellitic acid, naphthalenetricarboxylic acid, naphthalenetetracarboxylic acid, pyrenetricarboxylic acid, pyrenetetracarboxylic acid, and the like.

Particularly, among the multivalent carboxylic acids, it is preferable to use azelaic acid, sebacic acid, 1,9-nonandicarboxylic acid, 1,10-decamethylenecarboxylic acid, 1,11-undecanedicarboxylic acid, 1,12-dodecanedicarboxylic acid, terephthalic acid, trimellitic acid, pyrromellitic acid, and the like. Because these multivalent carboxylic acids are poorly soluble or insoluble in water, the ester synthesizing reaction proceeds in a suspension in which the multivalent carboxylic acid is dispersed in water.

The polyol refers to a compound which contains two or more hydroxyl groups in one molecule. Among the polyols, the bivalent polyol is a compound which contains two hydroxyl groups in one molecule, and examples thereof include ethyleneglycol, propyleneglycol, butanediol, diethyleneglycol, hexanediol, cyclohexanediol, octanediol, decanediol, dodecanediol, and the like. In addition, as the polyols other than the bivalent polyol, examples thereof include glycerin, pentaerythritol, hexamethylolmelamine, hexaethylolmelamine, tetramethylolbenzoguanamine, tetraethylolbenzoguanamine, and the like.

Particularly, among the polyols, it is preferable to use the bivalent polyols, such as 1,8-octanediol, 1,10-decanediol, 1,12-dodecanediol, and the like. Because these polyols are poorly soluble or insoluble in water, the ester synthesizing reaction proceeds in a suspension in which the polyol is dispersed in water.

In addition, by combining these polycondensable monomers, a non-crystalline resin or a crystalline resin can be easily obtained.

Examples of the multivalent carboxylic acids to be used to obtain a crystalline polyester or a non-crystalline polyamide include oxalic acid, malonic acid, succinic acid, glutaric acid, adipic acid, pimelic acid, suberic acid, azelaic acid, sebacic acid, maleic acid, fumaric acid, citraconic acid, itaconic acid, glutaconic acid, n-dodecylsuccinic acid, n-dodecenylsuccinic acid, isododecylsuccinic acid, isododecenylsuccinic acid, n-octylsuccinic acid, n-octenylsuccinic acid, and acid anhydrides thereof, or acid chlorides thereof.

In addition, as the polyol to be used for obtaining a crystalline polyester, examples thereof include ethyleneglycol, diethyleneglycol, triethyleneglycol, 1,2-propyleneglycol, 1,3-propyleneglycol, 1,4-butanediol, 1,4-butenediol, neopentylglycol, 1,5-pentaneglycol, 1,6-hexanglycol, 1,4-cyclohexanediol, 1,4-cyclohexanedimethanol, dipropyleneglycol, polyethyleneglyocl, polypropyleneglyocl, polytetramethyleneglycol, bisphenol A, bisphenol Z, hydrogenated bisphenol A, and the like.

In addition, as the polyamine to be used for obtaining the polyamide, examples thereof include ethylendiamine, diethylendiamine, triethylendiamine, 1,2-propylenediamine, 1,3-propylenediamine, 1,4-butanediamine, 1,4-butenediamine, 2,2-dimethyl-1,3-butanediamine, 1,5-pentanediamine, 1,6-hexanediamine, 1,4-cyclohexanediamine, 1,4-cyclohexanedimethylamine, and the like.

The polycondensed fine resin particles obtained by polycondensation of such a polycondensable monomer are preferably crystalline. Particularly, by using a crystalline resin, toner fusion at low-temperature can be easily realized.

Examples of such a crystalline polycondensed resin include a polyester obtained by causing a reaction between 1,9-nonandiol, 1,10-decamethylenecarboxylic acid, or between cyclohexanediol and adipic acid; a polyester obtained by causing a reaction between 1,6-hexanediol and sebasic acid; a polyester obtained by causing a reaction between ethyleneglycol and succinic acid; a polyester obtained by causing a reaction between ethyleneglycol and sebasic acid; and a polyester obtained by causing a reaction between 1,4-butanediol and succinic acid. Among these, a polyester obtained by causing a reaction between 1,9-nonandiol, 1,10-decamethylenecarboxylic acid; and that obtained by causing a reaction between 1,6-hexanediol and sebasic acid are particularly more preferable.

Herein, the adequate range of crystal melting point Tm for the crystalline polycondensed resin is from about 50 to about 120° C., and is preferably from about 55 to about 90° C. If the value of Tm is below 50° C., the cohesive force of the binder resin itself in the higher temperature region is lowered, and thus deterioration of the peelability or hot offset may tend to be caused during fixing. In addition, if the value of Tm exceeds 120° C., a sufficient fusion is not obtained, and the minimum fixing temperature may be raised.

Herein, the melting point for a crystalline resin can be determined as the melting peak temperature in the power compensation type differential scanning colorimetry as defined in JIS K-7121 (Testing methods for transition temperatures of plastics) when measurement is made at a rate of 10° C. per minute from room temperature to 150° C. by using a differential scanning calorimeter (DSC). Some crystalline resins may exhibit a plurality of melting peaks, however, in the present invention, the maximum peak is regarded as the meting point.

On the other hand, when the polycondensed fine resin particles are non-crystalline, the adequate range of glass transition point Tg is from about 50 to about 80° C., and is preferably about 50 to about 65° C. If the value of Tg is below 50° C., the cohesive force of the binder resin itself in the higher temperature region is lowered, and thus hot offset may tend to be caused during fixing. In addition, if the value of Tg exceeds 80° C., a sufficient fusion is not obtained, and the minimum fixing temperature may be raised.

The glass transition point for a non-crystalline resin refers to the value determined by the method (DSC method) as defined in ASTM D3418-82.

Herein, whether a resin is crystalline or not can be determined by using a heat absorption curve obtained by the above-mentioned method in accordance with the definition of melting point as given in JIS K-7121. Specifically, a specific resin has been determined to have a crystallinity when the temperature difference between the intersection (the melting start point) of a straight line drawn by extending the base line on the lower temperature side toward the higher one with a tangent line drawn at the point providing a maximum slope on the curve on the lower temperature side of the melting peak (heat absorption peak), and the intersection (the melting end point) of a straight line drawn by extending the base line on the higher temperature side toward the lower one with a tangent line drawn at the point providing a maximum slope on the curve on the higher temperature side of the melting peak (heat absorption peak) is 50° C. or less, and the morphology of the curve shows no stepwise geometry as given in the same JIS K-7121.

In addition, the adequate range of weight-average molecular weight for the polycondensed fine resin particles obtained by polycondensation of a polycondensable monomer is about 1500 to about 60,000, and is preferably about 3000 to about 40,000. If the weight-average molecular weight is less than 1500, the cohesive force of the binder resin tends to be lowered, and thus the hot offset resistance may be lowered, and if the weight-average molecular weight exceeds 60,000, the minimum fixing temperature may be raised although the hot offset resistance is kept good. In addition, depending upon the selected carboxylic acid valence or alcohol valence of the monomer, and the like, the polycondensed fine resin particles may partly have a branch, crosslink, or the like.

In addition, the adequate range of number-average molecular weight for the polycondensed fine resin particles obtained by polycondensation of a polycondensable monomer is about 2000 to about 10,000, and is preferably about 3000 to about 7000. If the number-average molecular weight is less than 2000, an unsatisfactory image strength or a trouble due to the stickiness feeling of the image when the polycondensed fine resin particles are used as the toner resin may be caused, and if the number-average molecular weight exceeds 10,000, the fixability at low temperatures may be degraded.

Herein, the number-average molecular weight was measured under the following conditions. The values of weight-average molecular weight Mw and number-average molecular weight Mn can be determined by various methods, and the result may slightly vary depending upon the method of measurement, however, in the present invention, the following method of measurement was used. Specifically, using the gel permeation chromatography (GPC), the weight-average molecular weight Mw and number-average molecular weight Mn are determined under the conditions described below. At a temperature of 40° C., the solvent (tetrahydrofran) is caused to flow at a rate of 1.2 ml/min, and a tetrahydrofran/sample solution with a concentration of 0.2 g per 20 ml is poured by 3 mg as a sample weight. In determination of the molecular weight of the sample, the measurement conditions under which the molecular weight possessed by the pertinent sample is involved in the range where the logarithm of the molecular weight of the calibration curve constructed from a few different types of monodispersible polystyrene standard samples and the number of counts provide a straight line are selected.

The reliability of the measurement result can be verified by confirming that the NBS706 polystyrene standard sample which was used under the above-mentioned measurement conditions provides a weight-average molecular weight Mw of 28.8×10⁴, and a number-average molecular weight Mn of 13.7×10⁴.

In addition, the GPC column to be used, any column may be adopted, provided that the conditions are met. Specifically, for example, the TSK-GEL GMH (manufactured by TOSOH CORPORATION), and the like can be used. The solvent and the measuring temperature are not limited to those meeting the requirements as given above, and may be changed as appropriate.

In addition, the volumetric center particle diameter of the polycondensed fine resin particles obtained by polycondensation of a polycondensable monomer is preferably about 10 (m or less; is more preferably about 7 (m or less, and is most preferably about 1 (m or less. If this particle diameter exceeds 10 (m, the polycondensed fine resin particles, when used as the toner, will have an undesirable effect on the image quality characteristics, such as the resolution, and the like. Further, if the particle diameter exceeds 10 (m, there will arise manufacturing problems of an increase in the molecular weight in polycondensation, and an insufficient speed thereof, and a problem with the image quality and the image strength after fixing.

In order to obtain polycondensed fine resin particles having a prescribed particle diameter in such an aqueous medium, the method which utilizes the non-uniform system polymerization morphology in the normal aqueous medium, such as the suspension polymerization method, the fusion suspension method, the mini-emulsion method, the micro-emulsion method, the micron emulsion method, the multi-stage lubrication method, the emulsification polymerization method involving seed polymerization, and the like is recommended to be used as the polymerization method. In addition, in this case, the polycondensation reaction, particularly, the final molecular weight and the polymerization speed depend upon the final particle diameter as described above, thus, as the manufacturing morphology which can achieve the size of 1 (m, as the most preferable particle morphology, and yet efficient manufacture, the polymerization method, such as the mini-emulsion method, the micro-emulsion method, or the like, which provides the sub-micron (less-than-one micron) size as the final particle morphology thereof is more preferable.

In addition, the median diameter (center diameter) of the polycondensed fine resin particles obtained by polycondensation of a polycondensable monomer is about 0.05 (m to about 2.0 (m, however, preferably, about 0.1 (m to about 1.5 (m; more preferably, about 0.1 (m to about 1.0 (m. By holding this median diameter within the above-mentioned range, the dispersion state of the polycondensed fine resin particles in an aqueous medium becomes stable. Therefore, if this median diameter is too small in the toner manufacture, the aggregatability in particulization is degraded; free fine resin particles tend to be generated; and the viscosity of the system tends to be increased, which may render the control of the particle diameter difficult. On the other hand, if the median diameter is too large, coarse powder tends to be produced, resulting in the particle size distribution being degraded, with the release agent, such as wax and the like, tending to become free, and thus the releasability and the offset occurrence temperature in fixing may be lowered.

Herein, the median diameter of the polycondensed fine resin particles can be measured by use of, for example, a laser diffraction type particle size distribution measuring apparatus (LA-920, manufactured by HORIBA, Ltd.).

In addition, it is preferable that the polycondensed fine resin particles be not only in the above-mentioned range, but also free from occurrence of ultra-fine powder and ultra-coarse one, and the percentage of the polycondensed fine resin particles having a particle diameter of 0.03 μm or less, or 5.0 μm or over is preferably 10% or less of the whole, and is more preferably 5% or less. This percentage can be obtained by plotting the relationship between the particle diameter and the cumulative frequency from the result of the measurement using the LA-920, and determining it from the cumulative frequency for 0.03 μm or less, or 5.0 μm or over.

Herein, in order to control the median diameter of the polycondensed fine resin particles obtained to within the above-mentioned range or the percentage of the polycondensed fine resin particles having too large a particle diameter or too small a particle diameter to a low value, it is preferable that, for example, one of the following techniques be used.

1) The technique which mixes the polycondensable monomer with the other additives (for example, the polycondensation catalyst and the surfactant), and melts these once, without directly adding the polycondensable monomer into an aqueous medium; then adds this oily solution into an aqueous medium; gives a first stir to the solution (for example, stirring it with a homogenizer); and further gives a second stir to the solution (for example, stirring it with an ultrasonic wave) for emulsification or dispersion thereof;

2) The technique which mixes the polycondensable monomer with the other additives (for example, the polycondensation catalyst and the surfactant), and melts these; then adds this oily solution into an aqueous medium heated to 100° C. or so, for example, and stirs and emulsifies the solution (stirs and emulsifies it with a homogenizer, for example); and further atomizes, emulsifies, or disperses it (atomizes, emulsifies, or disperses it with the use of, for example, Nanomizer manufactured by YOSHIDA KIKAI Co., Ltd., or the like);

3) The technique which mixes the polycondensable monomer with the other additives (for example, the polycondensation catalyst and the surfactant), and melts these; then, after adding a small amount of solvent (for example, ethyl acetate, and the like) to this oily solution, adds the solution into an aqueous medium, stirs and emulsifies it (stirs and emulsifies it with a homogenizer, for example); further atomizes, emulsifies, or disperses it (atomizes, emulsifies, or disperses it with the use of, for example, Nanomizer manufactured by YOSHIDA KIKAI Co., Ltd., or the like); and then while heating the solution to 60° C. or so, for example, stirs it to remove the solvent;

4) The technique which mixes the polycondensable monomer with the other additives (for example, the polycondensation catalyst and the surfactant), and melts these; into that oily solution, gradually adds an aqueous medium heated to 100° C. or so, for example, while stirring and emulsifying the solution (stirring and emulsifying it with a homogenizer, for example); and further adds an aqueous medium, and if necessary, a surfactant to the solution for realizing phase inversion and emulsification thereof;

and the like.

In addition, the particle size distribution characteristic of the polycondensed fine resin particles obtained by polycondensation of a polycondensable monomer can be expressed by the percentage of the ultrafine particles or coarse particles; for example, saying that the percentage of the polycondensed fine resin particles having a particle diameter of 0.03 μm or less, or 5.0 μm or more is 10% or less of the whole. Further, use of the coefficient of variation which is directly calculated by means of a measuring instrument, such as a laser diffraction type particle size distribution measuring apparatus (LA-920, manufactured by HORIBA, ltd.), or the like, is a general practice.

Herein, the coefficient of variation is the ratio of the arithmetic standard deviation to the average value expressed by percentage. When the particle size distribution of the polycondensed fine resin particles is expressed by the coefficient of variation, it is preferably 40% or less, and is more preferably 35% or less.

With respect to the manufacturing method for dispersion of fine resin particles of the present invention, when the polycondensable monomer is polycondensed in an aqueous medium, the above-mentioned respective materials are emulsified or dispersed into an aqueous medium by using, for example, mechanical shearing force, ultrasonic wave, or the like, and in this emulsification or dispersion, a surfactant, a macromolecular dispersing agent, an inorganic dispersing agent, and the like can be added into an aqueous medium, as required.

Examples of the surfactant to be used here include anionic surfactants, such as sulfuric acid ester salt ones, sulfonic acid ester salt ones, phosphoric acid ester salt ones, and the like; cationic surfactants, such as amine salt type ones, quaternary ammonium salt type ones, and the like; nonionic surfactants, such as polyethyleneglycol ones, alkylphenolethyleneoxide adduct ones, polyhydric alcohol ones, and the like; and the like. Among these, the anionic surfactants, and the cationic surfactants are preferable. The nonionic surfactants are preferably used in combination with the anionic surfactant or the cationic surfactant. The surfactants may be used alone or in mixture of two or more types. Examples of the anionic surfactant include sodium dodecylbenzenesulfonate, sodium alkylnaphthalenesulfonate, sodium arylalkylpolyethersulfonate, sodium 3,3-disulfonediphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-(-naphthol-6-sulfonate, sodium dialkylsulfosuccinate, sodium dodecylsulfate, sodium tetradecylsulfate, sodium pentadecylsulfate, sodium octylsulfate, sodium oleate, sodium lauriate, sodium capriate, sodium caprylate, sodium capronate, potassium stearate, calcium oleate, and the like. Examples of the cationic surfactant include alkylbenzendimethylammonium chloride, alkyltrimethylammonium chloride, distearylammonium chloride, and the like. Examples of the nonionic surfactant include polyethyleneoxide, polypropyleneoxide, combination between polypropyleneoxide and polyethyleneoxide, ester between polyethyleneglycol and a higher fatty acid, alkylphenolpolyethyleneoxide, ester between a higher fatty acid and polyethyleneglycol, ester between a higher fatty acid and polypropyleneoxide, sorbitane ester, and the like. In addition, examples of the macromolecular dispersing agent include sodium polycarbonate, polyvinylalcohol, and the like, and examples of the inorganic dispersing agent include carbonic acid, and the like, however, these do not limit the present invention in any way. Further, in order to prevent the Ostwald Ripening phenomenon of the monomer emulsion in a normal aqueous medium, a higher alcohol, represented by heptanol and octanol, or a higher aliphatic hydrocarbon, represented by hexadodecan, can often be compounded as a stabilization assistant agent.

In polycondensation of the polycondensed fine resin particles in an aqueous medium, the fixing assistants, such as the coloring agent and wax, and the like, the charging assistant, and other components which are normally necessary for a toner can also be previously mixed into an aqueous medium, and be compounded into the polycondensed fine resin particles together with the polycondensation.

(Electrostatic Charge Image Developing Toner)

Hereinbelow, the method for manufacturing the electrostatic charge image developing toner of the present invention will be described. The method for manufacturing the electrostatic charge image developing toner of the present invention comprises the steps of at least: in a dispersion in which fine resin particles are dispersed, aggregating the fine resin particles to obtain aggregated particles (aggregation process); and heating the aggregated particles for causing them to be fused with one another (fusion process). And, with respect to this manufacturing method called the emulsification polymerization method, the above-mentioned dispersion of fine resin particles of the present invention is applied as a dispersion in which fine resin particles are dispersed.

In the aggregation process, the polycondensed fine resin particles in the above-mentioned dispersion of fine resin particles of the present invention are prepared in an aqueous medium, thus they can be utilized as a resin dispersion as they are. This dispersion of fine resin particles is mixed with a dispersion of coloring agent particles and a dispersion of release agent particles as required, and by adding an aggregation agent for hetero aggregation of these particles, aggregated particles of the toner diameter can be formed. In addition, after carrying out such an aggregation to form a first aggregated particle, the above-mentioned dispersion of fine resin particles of the present invention or another dispersion of fine resin particles can be further added to form a second shell layer on the first particle surface. In this exemplification, the coloring agent dispersion is separately prepared, however, when a coloring agent dispersion is previously compounded into the polycondensed fine resin particles, there is no need for separate preparation of the coloring agent dispersion.

Herein, as the aggregation agent, an inorganic salt, and a bi- or higher valent metallic salt can be preferably used in addition to the surfactant. Particularly, using a metallic salt is preferable for controlling the characteristics, such as the aggregatability, the toner chargeability, and the like. In addition, the surfactant can be used for such a purpose as emulsification polymerization of a resin, dispersion of a pigment, dispersion of fine resin particles, dispersion of a releasing agent, aggregation, stabilization of aggregated particles, and the like. Specifically, anionic surfactants, such as sulfuric acid ester salt ones, sulfonic acid ester salt ones, phosphoric acid ester salt ones, soap ones, and the like; cationic surfactants, such as amine salt type ones, quaternary ammonium salt type ones, and the like; and nonionic surfactants, such as polyethyleneglycol ones, alkylphenolethyleneoxide adduct ones, polyhydric alcohol ones, and the like; are effectively used in conjunction, and as the dispersion means, such general one as a rotary shearing type homogenizer, a ball mill with media, a sand mill, Dynomill, or the like can be used.

In addition, as a dispersion of fine resin particles other than the above-mentioned dispersion of fine resin particles of the present invention, an addition polymerization dispersion of fine resin particles that is manufactured by using the conventionally known emulsification polymerization method or the like can also be used.

Examples of the addition polymerization monomer for manufacturing of an addition polymerization dispersion of fine resin particle include styrenes, such as styrene, parachlorstyrene, and the like; vinyl esters, such as vinylnaphthalene, vinyl chloride, vinyl bromide, vinyl fluoride, vinyl acetate, vinyl propyonate, vinyl benzoate, vinyl butyrate, and the like; methylene aliphatic carboxylic acid esters, such as acrylic acid methylester, acrylic acid ethylester, acrylic acid n-butylester, acrylic acid isobutylester, acrylic acid dodecylester, acrylic acid n-octylester, acrylic acid 2-chlorester, acrylic acid phenylester, (-chloracrylic acid methylester, methacrylic acid methylester, methacrylic acid ethylester, methacrylic acid butylester, and the like; acrylonitrile; methacrylonitrile; acrylamide; vinyl ethers, such as vinyl methyl ether, vinyl ethyl ether, vinyl isobutyl ether, and the like; monomers with an N-polarity-having group, such as N-vinyl compounds, and the like, such as N-vinylpyrrole, N-vinylcarbazole, N-vinylindole, N-vinylpyrrolidone, and the like; homopolymers and copolymers of vinyl monomers, such as vinyl carboxylic acids, and the like, such as metharylic acid, acrylic acid, cinnamic acid, carboxylethyl acrylate, and the like; and the like; and further various waxes can also be used.

With an addition polymerization monomer, a dispersion of fine resin particles can be manufactured by using an ionic surfactant or the like to carry out the emulsification polymerization. With any other type of resin, provided that it is oily and is soluble in solvents having a relatively low solubility in water, a dispersion of fine resin particles can be obtained by dissolving the resin into any one of the solvents; particulately dispersing the solution into an aqueous medium together with an ionic surfactant or a macromolecular electrolyte by means of a dispersing machine, such as a homogenizer or the like; and then heating or evacuating the solution to transpire the solvent.

Then, after passing through the aggregation process, the aggregated particles are heated to a temperature above the glass transition point or melting point for the fine resin particles in the fusion process (the fusion/coalescence process) for fusing/coalescing the aggregated particles, and by cleaning and drying the product, as required, the toner can be obtained.

In addition, after the fusion process, the product can be optionally passed through the cleaning process, the solid-liquid separation process, and the drying process before desired toner particles being provided. In consideration of the chargeability, the cleaning process is preferably implemented by carrying out sufficient substitution cleaning with deionized water. In addition, the solid-liquid separation process is not particularly limited, but from the viewpoint of productivity, suction filtering, pressurized filtering, and the like are preferable. Further, the drying process is also not particularly limited, but from the viewpoint of productivity, freeze drying, flash jet drying, fluidized drying, vibration type fluidized drying, and the like are preferably used.

Hereinbelow, the constitutional components of the toner (the raw materials used for manufacture thereof) will be described.

First, as the coloring agent, the following items can be used.

Examples of the black pigment include carbon black, copper oxide, manganese dioxide, aniline black, activated carbon, nonmagnetic ferrite, magnetite, and the like.

Examples of the yellow pigment include chrome yellow, zinc yellow, yellow iron oxide, cadmium yellow, chrome yellow, Hansa yellow, Hansa yellow 10G, benzidine yellow G, benzidine yellow GR, threne yellow, quinoline yellow, permenent yellow NCG, and the like.

Examples of the orange pigment include orange chrome yellow, molybdenum orange, permanent orange GTR, pyrazolone orange, Balcan orange, benzine orange G, induthrene brilliant orange RK, induthrene brilliant orange GK, and the like.

Examples of the red pigment include red oxide, cadmium red, red lead, red mercury sulfide, watchung red, permanent red 4R, lithol red, brilliant carmine 3B, brilliant carmine 6B, Dupont oil red, pyrazolone red, rhodamine B, lake, lake red C, rose Bengal, eoxine red, alizarin lake, and the like.

Examples of the blue pigment include Prussian blue, cobalt blue, alkali blue lake, Victoria blue lake, fast sky blue, induthrene blue BC, aniline blue, ultramarine blue, Calco oil red, methylene blue chloride, phthalocyanine blue, phthalocyanine green, malachite green oxalorate, and the like.

Examples of the purple pigment include manganese purple, fast violet B, methyl violet lake, and the like.

Examples of the green pigment include chrome oxide, chrome green, pigment green, malachite green lake, final yellow green C, and the like.

Examples of the white pigment include Chinese white, titanium oxide, antimony white, zinc sulfide, and the like.

Examples of the loading pigment include Baryte powder, barium carbonate, clay, silica, white carbon, talc, alumina white, and the like.

In addition, examples of the dyestuff include various dyestuffs, such as basic, acidic, dispersion, substantive dyestuffs, and the like, such as nigrosine, methylene blue, rose Bengal, quinoline yellow, ultramarine blue, and the like.

These coloring agents are used alone or in mixture. With these coloring agents, a dispersion of coloring agent particles can be prepared by using, for example, a media type dispersing machine, such as a rotary shearing type homogenizer, a ball mill, a sand mill, an attriter, or the like, or a high-pressure opposing collision type dispersing machine, or the like. In addition, these coloring agents can also be dispersed into an aqueous medium by using a surfactant having a polarity and a homogenizer.

The coloring agent is selected from the viewpoints of hue angle, saturation, lightness, weathering resistance, OHP permeability, and dispersibility in toner.

The coloring agent can be added in the range of 4 to 15 percent by weight of the total weight of the solid content constituting the toner. When a magnetic substance is used as the black coloring agent, 12 to 240 percent by weight can be added unlike the other coloring agents.

The amount of admixture provides the amount which is required to assure the color development capability in fixing. In addition, by providing the coloring agent particles with a center diameter (median diameter) of 100 to 330 nm, the OHP permeability and the color development capability can be assured.

The center diameter (median diameter) of the coloring agent particles was measured by using, for example, a laser diffraction type particle size distribution measuring apparatus (LA-920, manufactured by HORIBA, ltd.).

In addition, when the coloring agent is to be used as a magnetic toner, it may contain magnetic powder. Specifically, a substance which is magnetized in the magnetic field is used, and powder of a ferromagnetic substance, such as iron, cobalt, nickel, or the like, or a compound, such as ferrite, magnetite, or the like, is used. When the toner is obtained in the aqueous phase, there is the need for paying attention to the aqueous phase migration of the magnetic substance, and it is preferable that the surface of the magnetic substance be previously modified; preferably, such a treatment as hydrophobic treatment being previously provided.

In addition, as the internal additive, a magnetic substance, such as a metal or alloy, such as ferrite, magnetite, reduced iron, cobalt, nickel, manganese, or the like, or a compound containing such a metal, and the like can be used, and as the charging control agent, any of the various charging control agents which are normally used, such as a quaternary ammonium chloride compound, a nigrosine compound, a dyestuff consisting of a complex of aluminum, iron, chromium, or the like, a triphenylmethane pigment, and the like can be used. From the viewpoints of control of the ionic strength which can have an effect on the stability in aggregation and coalescence, and reduction of the waste water contamination, the material which is poorly soluble in water is preferable.

Examples of the release agent include low-molecular weight polyolefines, such as various ester waxes, polyethylene, polypropylene, polybutene, and the like; silicones exhibiting a softening point when subjected to heating; fatty acid amides, such as oleic acid amide, erucic acid amide, ricinoleic acid amide, stearic acid amide, and the like; vegetable waxes, carnauba wax, rice wax, candelilla wax, Japan wax, jojoba oil, and the like; animal waxes, such as beeswax; mineral/petroleum waxes, such as Montan wax, ozokerite, ceresine, paraffin wax, microcrystalline wax, Fisher-Tropsh wax, and the like; and modifications thereof, and the like.

These waxes will practically not be dissolved in a solvent, such as toluene, near at room temperature, or if dissolved, only a very small amount.

With any of these waxes, a dispersion of particles of 1 μm or smaller can be manufactured by dispersing it together with an ionic surfactant and a macromolecular electrolyte, such as a macromolecular acid, a macromolecular base, or the like, in an aqueous medium, heating the solution to above the melting point of the wax, and particulately dispersing it by the use of a homogenizer with a strong shearing force-giving capability or a high-pressure discharge type dispersing machine (Gaulin Homogenizer, manufactured by Gaulin, Inc.).

The coloring agent is preferably added in the range of 5 to 25 percent by weight of the total weight of the solid content constituting the toner in view of the necessity for assuring the peelability of the fixed image in the oilless fixing system.

The particle diameter in the dispersion of release agent particles was measured by using, for example, a laser diffraction type particle size distribution measuring apparatus (LA-920, manufactured by HORIBA, ltd.). When the release agent is to be used, it is preferable that the aggregation of the fine resin particles, the coloring agent particles, and the release agent particles be followed by further adding the dispersion of fine resin particles for causing fine resin particles to be adhered to the surface of the aggregated particles, from the viewpoint of assurance of chargeability and durability.

The adequate range of cumulative volume-average particle diameter D50 for the toner obtained by the method for manufacturing of electrostatic charge image developing toner of the present invention is 3.0 to 9.0 μm, and is preferably 3.0 to 5.0 μm. If the value of D50 is under 3.0 μm, the adhesive force may be increased, and the developability be lowered. On the other hand, if the value of D50 exceeds 9.0 μm, the resolution of the image may be lowered.

In addition, the volume-average particle size distribution index GSDv for the toner obtained is preferably 1.30 or less. If the GSDv is over 1.30, the resolution of the image may be lowered, and may cause such an image defect as scattered toner, fog, or the like.

Herein, for the cumulative volume-average particle diameter D₅₀ and the average particle size distribution index, a cumulative volume distribution curve and a cumulative number distribution curve are drawn from the side of the smaller particle size, respectively, for each particle size range (channel) as a result of division of the particle size distribution measured by using a measuring instrument, for example, a Coulter Counter TAII (manufactured by Nikkaki), a Multisizer II (manufactured by Nikkaki), or the like, and the particle diameter providing 16% cumulative is defined as volume D₁₆ᵥ and number D₁₆ₚ; that providing 50% cumulative being defined as volume D₅₀ᵥ and number D₅₀ₚ; and that providing 84% cumulative being defined as volume D₈₄ᵥ and number D₈₄ₚ. Using these values, the volume-average particle size distribution index GSDv is calculated as (D₈₄ᵥ/D₁₆ᵥ)^{1/2}, and the number-average particle size distribution index GSDp is calculated as (D₈₄ₚ/D₁₆ₚ)^{1/2}.

The range of shape factor SF1 for the toner obtained is 100 to 140, and is preferably 110 to 135, from the viewpoint of image formability. The shape factor SF1 can be determined as follows. First, the optical microscope image of the toner particles scattered on a slide glass was taken into a Luzex image analyzing apparatus through a video camera, and for 50 or more toner particles, the circumferential length (ML) and the projected area (A) were measured to determine the shape factor SF1 for the toner by the formula: SF1=ML²/A.

The obtained toner is dried as with the ordinary toner in order to give a fluidity and improve the cleanability, and then inorganic substance particles of silica, alumina, titania, calcium carbonate or the like, or fine resin particles of a vinyl resin, a polyester, a silicone, or the like are added onto the surface of the toner particles in the dried state, while being subjected to shearing, for service.

For example, when inorganic substance particles are to be adhered to the surface of the toner particles in an aqueous medium, any of the particles, such as those of silica, alumina, titania, calcium carbonate, magnesium carbonate, calcium triphosphate, and the like, which are generally used as an external additive to the toner, can be applied by dispersing them with an ionic surfactant and a macromolecular acid, or a macromolecular base.

The toner obtained by the method for manufacturing of electrostatic charge image developing toner of the present invention as described above is used as an electrostatic charge image developer. This developer is not particularly limited, except that it contains this electrostatic charge image developing toner, and can take an appropriate component composition according to the purpose. When the electrostatic charge image developing toner is used alone, it is prepared as an electrostatic charge image developer of one-component system, and when it is used in combination with a carrier, it is prepared as an electrostatic charge image developer of two-component system.

In addition, the electrostatic charge image developer (the electrostatic charge image developing toner) can be used for any image formation method of the ordinary electrostatic charge image developing system (the electrophotographic method system). Specifically, the image formation method of the present invention comprises, for example, the electrostatic latent image formation process, the toner image formation process, the transfer process, and the cleaning process. The respective processes themselves are general ones, and are disclosed in, for example, Japanese Laid-Open Publication No. 56-40868/1981, Japanese Laid-Open Publication No. 49-91231/1974, and the like. The image formation method of the present invention itself can be implemented with such a well-known image formation apparatus, such as a copying machine, a facsimile, or the like. The electrostatic latent image formation process is a process of forming an electrostatic latent image on an electrostatic latent image carrier. The toner image formation process is a process of developing the electrostatic latent image with a developer layer on the developer carrier to form a toner image. As the developer layer is not particularly limited, provided that it comprises the electrostatic charge image developer of the present invention that contains the electrostatic charge image developing toner of the present invention. The transfer process is a process of transferring the toner image onto an image receiving element. The cleaning process is a process of removing the electrostatic charge image developer being left on the electrostatic latent image carrier. For the image formation method of the present invention, an embodiment which further comprises a recycling process is preferable. The recycling process is a process of returning the electrostatic charge image developing toner recovered in the cleaning process to the developing layer. The image formation process of the aspect comprising this recycling process can be implemented with an image formation apparatus, such as a copying machine, a facsimile, or the like, of the toner recycling system type. Also, it is applicable to a recycling system of the aspect which omits the cleaning process, and recovers the toner simultaneously with the development.

### EXAMPLES

The present invention will be more specifically described with the following examples, however, the present invention is not limited to these.

In the present examples, the following dispersion of fine resin particles, the dispersion of coloring agent particles and the dispersion of release agent particles are prepared, respectively, and mixed in a prescribed ratio, being stirred, while a copolymer of a metallic salt being added for ionic neutralization to form particle aggregates. Then, an inorganic hydroxide is added for adjusting the pH value in the system from a weakly acidic value to the neutral value before heating the solution to a temperature above the crystal melting point or glass transition point of the fine resin particles for fusion/coalescence. After completion of the reaction, the product is subjected to sufficient cleaning, solid-liquid separation, and drying processes before providing a desired toner. Hereinafter, the respective preparation methods will be described.

(Preparation of Dispersion of Fine Resin Particles (1))

Dodecylbenzenesulfonic acid: 36 parts by weight
Deionized water: 1000 parts by weight

The above-mentioned components are mixed and dissolved to prepare an aqueous solution of dodecylbenzenesulfonic acid.
1,9-nonandiol: 80 parts by weight
1,10-decamethylenedicarboxylic acid: 115 parts by weight
Zeolite H-ZSM-5 fine particles: 1 part by weight
   (Volume-Average Particle Diameter: 0.32 μm, Hammet Acidity Function (Ho): −14.5)

Then, the above-mentioned components were mixed and heated to 140° C. to be melted, and the monomer melt in the cloudy state is retained for 5 minutes before being thrown into the above-mentioned aqueous dodecylbenzenesulfonic acid solution, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 10 hr, while being stirred, in the flask maintained at 80° C.

Thereby, a dispersion of crystalline polyester fine resin particles (1) having a median diameter of the fine particles of 650 nm, a melting point of 70° C., a weight-average molecular weight of 7500, a number-average molecular weight of 2200, a coefficient of variation of particle size distribution of 34%, and a solid content of 18%, can be obtained.

The zeolite H-ZSM-5 fine particles (hydrogen counter ion ZSM-5 type zeolite) can be prepared as follows:

First, into an aqueous solution in which 95.7 g of sodium silicate is dissolved in 120 g of deionized water, an aqueous solution in which 4.1 g of aluminum sulfate, 8 g of concentrated sulfuric acid, and 36 g of sodium chloride is dissolved in 160 g of deionized water is gradually added, while being stirred and mixed. Further, 12 g of tetrapropylammonium bromide is added into the solution, and after adjusting the pH to 10, stirring the solution in the autoclave at 170° C. for 15 hr will generate crystals. After filtering and separating these crystals, they are cleaned with deionized water, and dried.

Then, 2 g of the above-mentioned dried product is thrown into 50 ml of an aqueous 1 mol/L ammonium nitrate, and the solution is stirred and refluxed for 20 hr before being centrifugally separated, the precipitate being cleaned with deionized water 6 times, and then calcined at 120° C. for 3 hr, which is followed by being attrited for a long period of time with an automatic mortar for atomization to provide zeolite H-ZSM-5, which is the desired product.

(Preparation of Dispersion of Fine Resin Particles (2))

Sodium dodecylbenzenesulfonate: 36 parts by weight
Deionized water: 1000 parts by weight

The above-mentioned components are mixed and dissolved to prepare an aqueous dodecylbenzenesulfonic acid.
1,6-hexanediol: 59 parts by weight
Sebacic acid: 101 parts by weight
Sulfated zirconia (powder, manufactured by Wako Pure Chemical Industries): 1 part by weight

(That which was heated to 150° C. for 5 hours, and then attrited for a long period of time with an automatic mortar for atomization, having a volume-average particle diameter of 0.25 μm, and a Hammet acidity function (Ho) of −13.8)

Then, the above-mentioned components are mixed and heated to 140 deg C. to be melted, and the monomer melt in the cloudy state is retained for 5 minutes before being thrown into the above-mentioned aqueous dodecylbenzenesulfonic acid, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 10 hr, while being stirred, in the flask maintained at 90° C.

Thereby, a dispersion of crystalline polyester fine resin particles (2) having a median diameter of the fine particles of 350 nm, a melting point of 69° C., a weight-average molecular weight of 5800, a number-average molecular weight of 2200, a coefficient of variation of the particle size distribution of 33%, and a solid content of 16%, can be obtained.

(Preparation of Dispersion of Fine Resin Particles (3))

Dodecylsulfuric acid: 30 parts by weight
Deionized water: 1000 parts by weight

The above-mentioned components are mixed and dissolved to prepare an aqueous dodecylsulfuric acid.
1,9-nonandiol: 80 parts by weight
Azelaic acid: 94 parts by weight
Zirconia tungstate (powder, manufactured by Wako Pure Chemical Industries): 1 part by weight

(That which was heated to 150 C for 5 hr, and then attrited for a long period of time with an automatic mortar for atomization, having a volume-average particle diameter of 0.14 μm, and a Hammet acidity function (Ho) of −12.4)

Then, the above-mentioned components are mixed and heated to 130° C. to be melted, and the monomer melt in the cloudy state is retained for 5 minutes before being thrown into the above-mentioned aqueous dodecylsulfuric acid, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 8 hr, while being stirred, in the flask maintained at 70° C.

Thereby, a dispersion of crystalline polyester fine resin particles (3) having a median diameter of the fine particles of 180 nm, a melting point of 56° C., a weight-average molecular weight of 8200, a number-average molecular weight of 2700, a coefficient of variation of the particle size distribution of 32%, and a solid content of 17%, can be obtained.

(Preparation of Dispersion of Fine Resin Particles (4))

Isopropylbenzenesulfonic acid: 25 parts by weight
Deionized water: 500 parts by weight

The above-mentioned components are mixed and dissolved to prepare an aqueous isopropylbenzenesulfonic acid.
Terephthalic acid: 46 parts by weight
Polyoxyethylene(2,4)-2,2-bis(4-hydroxyphenyl)propane: 34 parts by weight
Ethyleneglycol: 20 parts by weight
Tungstosilisic acid: 1 part by weight

(That which was heated to 150° C. for 5 hr, and then attrited for a long period of time with an automatic mortar for atomization, having a volume-average particle diameter of 0.35 μm, and a Hammet acidity function (Ho) of −12.4)

Then, the above-mentioned components are mixed and heated to 160° C. to be melted, and the monomer melt in the cloudy state is retained for 5 minutes before being thrown into the above-mentioned aqueous isopropylbenzenesulfonic acid, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 10 hr, while being stirred, in the flask maintained at 90° C.

Thereby, a dispersion of non-crystalline polyester fine resin particles (4) having a median diameter of the fine particles of 650 nm, a glass transition point of 54° C., a weight-average molecular weight of 6200, a number-average molecular weight of 2500, a coefficient of variation of the particle size distribution of 32%, and a solid content of 14%, can be obtained.

(Preparation of Dispersion of Fine Resin Particles (5))

Scandium dodecylbenzenesulfonate: 36 parts by weight
Deionized water: 1000 parts by weight

The above-mentioned components are mixed and dissolved to prepare an aqueous scandium dodecylbenzenesulfonate.
1,9-nonandiol: 80 parts by weight
1,10-decamethylenecarboxylic acid: 115 parts by weight
Zirconia molybdate (MoO₃—ZrO₂): 1 part by weight

(That which was heated to 150° C. for 5 hr, and then attrited for a long period of time with an automatic mortar for atomization, having a volume-average particle diameter of 0.28 μm, and a Hammet acidity function (Ho) of −12.4)

Then, the above-mentioned components are mixed and heated to 140° C. to be melted, and the monomer melt in the cloudy state is retained for 5 minutes before being thrown into the above-mentioned aqueous scandium dodecylbenzenesulfonate, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 10 hr, while being stirred, in the flask maintained at 80° C.

Thereby, a dispersion of crystalline polyester fine resin particles (5) having a median diameter of the fine particles of 270 nm, a melting point of 71° C., a weight-average molecular weight of 11,200, a number-average molecular weight of 3500, a coefficient of variation of the particle size distribution of 31%, and a solid content of 18%, can be obtained.

(Preparation of Dispersion of Fine Resin Particles (6))

Dodecylbenzenesulfonic acid: 12 parts by weight
Deionized water: 1000 parts by weight

The above-mentioned components are mixed and dissolved to prepare an aqueous dodecylbenzenesulfonic acid.
Lipase (derived from genus Pseudomonas): 50 parts by weight
1,9-nonandiol: 80 parts by weight
1,10-decamethylenecarboxylic acid: 115 parts by weight
Cesium phosphotungstate (Cs_{2.5}H_{0.5}PW₁₂O₄₀): 1 part by weight

(That which was heated to 150° C. for 5 hr, and then attrited for a long period of time with an automatic mortar for atomization, having a volume-average particle diameter of 0.36 μm, and a Hammet acidity function (Ho) of −12.4)

Then, the above-mentioned components are mixed and heated to 120° C. to be melted, and the monomer melt in the cloudy state is thrown into the above-mentioned aqueous dodecylbenzenesulfonic acid, and then emulsified with a homogenizer (Ultra-Tarrax; manufactured by IKA Labortechnik GmbH) for 5 minutes. Thereafter, the emulsified product is retained for 15 hr, while being stirred, in the flask maintained at 80° C.

Thereby, a dispersion of crystalline polyester fine resin particles (6) having a median diameter of the fine particles of 1400 nm, a melting point of 68° C., a weight-average molecular weight of 5500, of number-average molecular weight of 2100, a coefficient of variation of the particle size distribution of 35%, and a solid content of 20%, can be obtained.

(Preparation of Dispersion of Fine Resin Particles (7))

Dodecylbenzenesulfonic acid: 18 parts by weight
Deionized water: 1000 parts by weight

The above-mentioned components are mixed and dissolved to prepare an aqueous dodecylbenzenesulfonic acid.
1,9-nonandiol: 80 parts by weight
1,10-decamethylenedicarboxylic acid: 115 parts by weight
Zeolite H-ZSM-5 fine particles: 1 part by weight

(with a volume-average particle diameter of 0.32 μm, and a Hammet acidity function (Ho) of −14.5)

Then, the above-mentioned components are mixed and heated to 120° C. to be melted, and then retained for 5 minutes before being thrown into the above-mentioned aqueous dodecylbenzenesulfonic acid, and then being emulsified with a homogenizer (Ultra-Tarrax; manufactured by IKA Labortechnik GmbH) for 1 minutes. Thereafter, the emulsified product is retained for 10 hr, while being stirred, in the flask maintained at 60° C.

Thereby, a dispersion of crystalline polyester fine resin particles (7) having a median diameter of the fine particles of 2300 nm, a melting point of 68° C., a weight-average molecular weight of 4300, a number-average molecular weight of 1700, a coefficient of variation of the particle size distribution of 38%, and a solid content of 18%, can be obtained.

(Preparation of Dispersion of Fine Resin Particles (8))

Dodecylbenzenesulfonic acid: 18 parts by weight
Deionized water: 1000 parts by weight

The above-mentioned components are mixed and dissolved to prepare an aqueous dodecylbenzenesulfonic acid.
1,4-butanediol: 45 parts by weight
Azelaic acid: 94 parts by weight
Sulfated zirconia (powder, manufactured by Wako Pure Chemical Industries): 1 part by weight

(with a volume-average particle diameter of 0.25 μm, and a Hammet acidity function (Ho) of −13.8)

Then, the above-mentioned components are mixed and heated to 140° C. to be melted, and the monomer melt in the cloudy state is retained for 5 minutes before being thrown into the above-mentioned aqueous isopropylbenzenesulfonic acid, and then emulsified with a homogenizer (Ultra-Tarrax; manufactured by IKA Labortechnik GmbH) for 5 minutes. Thereafter, after the solution further being emulsified in the ultrasonic bath for 5 minutes, the emulsified product is retained for 10 hours, while being stirred, in the flask maintained at 70° C.

Thereby, a dispersion of crystalline polyester fine resin particles (8) having a median diameter of the fine particles of 160 nm, a melting point of 48° C., a weight-average molecular weight of 7100, number-average molecular weight of 2500, a coefficient of variation of the particle size distribution of 35%, and a solid content of 15%, can be obtained.

(Preparation of Dispersion of Fine Resin Particles (9))

Styrene: 460 parts by weight
n-butylacrylate: 140 parts by weight
Acrylic acid: 12 parts by weight
Dodecanthiol: 9 parts by weight

The above-mentioned components are mixed and dissolved to prepare a solution.

On the other hand, 12 parts by weight of an anionic surfactant (Dowfax, manufactured by Rhodia Ltd.) is dissolved in 250 parts by weight of deionized water, and the solution is added thereto to be dispersed into the flask for being emulsified (monomer emulsified solution A is obtained). Further, 1 part by weight of the same surfactant (Dowfax, manufactured by Rhodia Ltd.) is dissolved in 555 parts by weight of deionized water, and laid in a flask for polymerization. The flask for polymerization is tightly capped; a refluxing tube is attached to the flask; and while nitrogen being introduced, the flask for polymerization is heated in the water bath to 75° C. with the solution being stirred, and then the solution is retained. 9 parts by weight of ammonium persulfate is dissolved in 43 parts by weight of deionized water, and the solution is dropped into the flask for polymerization through a metering pump over a 20-min time period before the monomer emulsified solution A being dropped also through a metering pump over a 200-min period. Thereafter, while the solution being continued to be slowly stirred, the flask for polymerization is maintained at 75° C. for 3 hr to complete the polymerization.

Thereby, a dispersion of fine resin particles (9) with which the median diameter of the fine particles is 210 nm, the glass transition point is 53.5° C., the weight-average molecular weight is 31,000, the number-average molecular weight is 9800, the coefficient of variation of the particle size distribution is 31%, the solid content is 42%, and the resin is a non-crystalline polyvinyl one can be obtained.

(Preparation of Dispersion of Coloring Agent Particles (1))

Yellow pigment (Y74, manufactured by Dainichiseika Color & Chemicals Mfg. Co., Ltd.): 50 parts by weight
Anionic surfactant (Neogen R, manufactured by DAI-ICHI KOGYO SEIYAKU CO., LTD.): 5 parts by weight
Deionized water: 200 parts by weight

By mixing and dissolving the components, and dispersing them with a homogenizer (Ultra-Tarrax; manufactured by IKA Labortechnik GmbH) for 5 minutes, and an ultrasonic bath for 10 minutes, a dispersion of yellow coloring agent particles (1) with which the median particle diameter is 240 nm, and the solid content is 21.5% can be obtained.

(Preparation of Dispersion of Coloring Agent Particles (2))

A dispersion of cyan coloring agent particles (2) having a median particle diameter of 190 nm, and the solid content of 21.5% can be obtained in the same manner as that for the coloring agent particles (1), except that a cyan pigment (copper phthalocyanin B15:3, manufactured by DAI-ICHI KOGYO SEIYAKU CO., LTD.) is used instead of the yellow pigment in preparation of the dispersion of coloring agent particles (1).

(Preparation of Dispersion of Coloring Agent Particles (3))

A dispersion of magenta coloring agent particles (3) having a median particle diameter of 165 nm, and the solid content of 21.5% can be obtained in the same manner as that for the coloring agent particles (1), except that a magenta pigment (PR122, manufactured by DAINIPPON INK AND CHEMICALS, INC.) is used instead of the yellow pigment in preparation of the dispersion of coloring agent particles (1).

(Preparation of Dispersion of Coloring Agent Particles (4))

A dispersion of black coloring agent particles (4) having a median particle diameter of 170 nm, and the solid content of 21.5% can be obtained in the same manner as that for the coloring agent particles (1), except that a black pigment (carbon black, manufactured by Cabot Corporation) is used instead of the yellow pigment in preparation of the dispersion of coloring agent particles (1).

(Preparation of Dispersion of Release Agent Particles)

Paraffin wax (HNP9, melting point 70° C., manufactured by NIPPON SEIRO, CO., LTD.): 50 parts by weight
Anionic surfactant (Dowfax, manufactured by Rhodia Ltd.): 5 parts by weight
Deionized water: 200 parts by weight

By heating the above-mentioned components to 95° C., and sufficiently dispersing them with a homogenizer (Ultra-Tarrax T50; manufactured by IKA Labortechnik GmbH), which is then followed by dispersion treatment with a high-pressure discharge type homogenizer (Gaulin Homogenizer, manufactured by Gaulin, Inc.), a dispersion of release agent particles with which the median particle diameter is 180 nm, and the solid content is 21.5% can be obtained.

### Example 1

{Toner 1}

(Preparation of Toner Particles)

Dispersion of fine resin particles (1): 233 parts by weight (42 parts by weight for resin)
Dispersion of fine resin particles (9): 50 parts by weight (21 parts by weight for resin)
Dispersion of coloring agent particles (1): 40 parts by weight (8.6 parts by weight for pigment)
Dispersion of release agent particles: 40 parts by weight (8.6 parts by weight for release agent)
Aluminum polychloride: 0.15 parts by weight
Deionized water: 300 parts by weight

The above-mentioned components (except for the dispersion of fine resin particles (9)) is sufficiently mixed and dispersed into a round stainless steel flask with a homogenizer (Ultra-Tarrax T50; manufactured by IKA Labortechnik GmbH). Thereafter, the flask is heated to 42° C. in an oil bath for heating, while stirring, which is then followed by adding 50 parts by weight of the dispersion of fine resin particles (9) (21 parts by weight for resin), and gently stirring the flask.

Thereafter, with an aqueous 0.5 mol/L sodium hydroxide, the pH level in the system is adjusted to 6.0, the solution is heated to 95° C., while being continued to be stirred. In the normal case, the pH in the system is lowered to 5.0 or less during the temperature rise to 95° C., however, herein, an aqueous sodium hydroxide is additionally dropped so as to prevent the pH level from being lowered down to 5.5 or less.

After completion of the reaction, the solution is cooled, filtered, and sufficiently cleaned with deionized water, which is followed by solid-liquid separation by use of a nutche filter. Then, the product is redispersed into 3 liters of deionized water at 40 deg C., and the solution is stirred at 300 rpm for 15 minutes for cleaning. This cleaning operation is repeated five times before carrying out solid-liquid separation by use of a nutche filter, which is then followed by vacuum drying for 12 hours to obtain toner particles.

The results of measurement of the diameters of these toner particles with a Coulter counter are: the cumulative volume-average particle diameter D₅₀ is 4.50 μm, and the volume-average particle size distribution index GSDv is 1.21. In addition, the shape factor SF1 for the toner particle that was determined by shape observation using a Luzex image analyzing apparatus is 132, indicating a potato-like shape.

By adding 1.2 parts by weight of a hydrophobic silica (TS720, manufactured by Cabot Corporation) to 50 parts by weight of the above-mentioned toner particles, and mixing them with a sample mill, an external additive toner can be obtained.

And, by using a ferrite carrier which has an average particle diameter of 50 μm, being 1% coated with polymethylmethacrylate (manufactured by Soken Chemical & Engineering Co., Ltd.), weighing the external additive toner such that the toner concentration is 5%, and stirring/mixing both for 5 minutes with a ball mill, a developer is prepared.

(Evaluation of Toner)

By using the above-mentioned developer; employing a J-Coat paper as a transfer paper in an improved model of DocuCenter Color 500 manufactured by Fuji Xerox Co., Ltd; and setting the process speed at 180 mm/sec, the fixability of the toner is examined. Then, it can be verified that the oilless fixability with the PFA tube fixing roll is good; the minimum fixing temperature (this temperature is determined on the image contamination resulting from the cloth rubbing of the image) is 120° C. or higher; and at this temperature, the image exhibits a sufficient fixability, and the transfer paper is peeled off with no resistance. The surface gloss of the image at a fixing temperature of 140° C. is as good as 60%; the developability and the transferability are both good; and a high-quality image with no image defects is provided. In addition, even at a fixing temperature of 200° C., occurrence of a hot offset cannot be observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (1) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of an-aggregate is utterly not observed, and thus the dispersion is in the stable state (the stability is evaluated “\textcircled{∘}” (the symbol will be described later)).

### Example 2

{Toner 2}

The toner particles are obtained in the same manner as that in EXAMPLE 1, except that, in EXAMPLE 1, according to the amounts of compounding as given in Table 1, the dispersion of fine resin particles (1) is changed into the dispersion of fine resin particles (2); the dispersion of coloring agent particles (1) is changed into the dispersion of coloring agent particles (2); and the pH level in heating the solution to 95° C. is maintained at 5.0.

With these toner particles, the cumulative volume-average particle diameter D₅₀ is 4.70 μm, and the volume-average particle size distribution index GSDv is 1.20. In addition, the shape factor SF1 is 122, indicating a substantially spherical shape.

By using these toner particles to obtain an externally additive toner as that in EXAMPLE 1; further preparing a developer; and examining the fixability of the toner in the same manner as that in EXAMPLE 1, it can be verified that the oilless fixability with the PFA tube fixing roll is good; the minimum fixing temperature (this temperature is determined on the image contamination resulting from the cloth rubbing of the image) is 110° C. or higher; and at this temperature, the image exhibits a sufficient fixability, and the transfer paper is peeled off with no resistance. The surface gloss of the image at a fixing temperature of 150° C. is as good as 60%; the developability and the transferability are both good; and a high-quality image with no image defects is provided. In addition, even at a fixing temperature of 200° C., occurrence of a hot offset cannot be observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (2) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of an aggregate is utterly not observed, and thus the dispersion is in the stable state (the stability is evaluated “\textcircled{∘}” (the symbol will be described later)).

### Example 3

{Toner 3}

The toner particles are obtained in the same manner in the same manner as that in EXAMPLE 1, except that, in EXAMPLE 1, according to the amounts of compounding as given in Table 1, the dispersion of fine resin particles (1) is changed into the dispersion of fine resin particles (3); the dispersion of fine resin particles (9) is changed into the dispersion of fine resin particles (4); the dispersion of coloring agent particles (1) is changed into the dispersion of coloring agent particles (3); and the amount of aluminum polychloride is changed into 0.12 parts by weight.

With these toner particles, the cumulative volume-average particle diameter D₅₀ is 4.10 μm, and the volume-average particle size distribution index GSDv is 1.20. In addition, the shape factor SF1 is 117, indicating a spherical shape.

By using these toner particles to obtain an externally additive toner in the same manner as that in EXAMPLE 1; further preparing a developer; and examining the fixability of the toner in the same manner as that in EXAMPLE 1, it can be verified that the oilless fixability with the PFA tube fixing roll is good; the minimum fixing temperature (this temperature is determined on the image contamination resulting from the cloth rubbing of the image) is 105° C. or higher; and at this temperature, the image exhibits a sufficient fixability, and the transfer paper is peeled off with no resistance. The surface gloss of the image at a fixing temperature of 150° C. is as good as 65%; the developability and the transferability are both good; and a high-quality image with no image defects is provided. In addition, even at a fixing temperature of 200° C., occurrence of a hot offset cannot be observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersions of fine resin particles (3) and (4) used is examined by the method which weighs off 100 g of the respective dispersions of fine resin particles into a 300-ml stainless steel beaker, respectively, and shearing-homogenizes them in the respective beakers by use of an IKA Ultra-Tarrax T50 for 1 minute, which is followed by filtering the respective dispersions of fine resin particles with a 77-μm nylon mesh to observe whether an aggregation is caused or not, (the shearing-homogenization method), occurrence of an aggregate is utterly not observed, and thus the respective dispersions are in the stable state (the stability is evaluated “\textcircled{∘}” (the symbol will be described later)).

### Example 4

{Toner 4}

The toner particles are obtained in the same manner as that in EXAMPLE 1, except that, in EXAMPLE 1, according to the amounts of compounding as given in Table 1, the dispersion of fine resin particles (1) is changed into the dispersion of fine resin particles (5).

With these toner particles, the cumulative volume-average particle diameter D₅₀ is 3.80 μm, and the volume-average particle size distribution index GSDv is 1.20. In addition, the shape factor SF1 is 133, indicating a potato-like shape.

By using these toner particles to obtain an externally additive toner in the same manner as that in EXAMPLE 1; further preparing a developer; and examining the fixability of the toner in the same manner as that in EXAMPLE 1, it can be verified that the oilless fixability with the PFA tube fixing roll is good; the minimum fixing temperature (this temperature is determined on the image contamination resulting from the cloth rubbing of the image) is 110° C. or higher; and at this temperature, the image exhibits a sufficient fixability, and the transfer paper is peeled off with no resistance. The surface gloss of the image at a fixing temperature of 150° C. is as good as 57%; the developability and the transferability are both good; and a high-quality image with no image defects is provided. In addition, even at a fixing temperature of 200° C., occurrence of a hot offset cannot be observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (5) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of an aggregate is utterly not observed, and thus the dispersion is in the stable state (the stability is evaluated “\textcircled{∘}” (the symbol will be described later)).

### Example 5

{Toner 5}

The toner particles are obtained in the same manner as that in EXAMPLE 1, except that, in EXAMPLE 1, according to the amounts of compounding as given in Table 1, the dispersion of fine resin particles (1) is changed into the dispersion of fine resin particles (6), and the dispersion of fine resin particles (9) is not used.

With these toner particles, the cumulative volume-average particle diameter D₅₀ is 3.70 μm, and the volume-average particle size distribution index GSDv is 1.24. In addition, the shape factor SF1 is 121, indicating a spherical shape.

By using these toner particles to obtain an externally additive toner in the same manner as that in EXAMPLE 1; further preparing a developer; and examining the fixability of the toner in the same manner as that in EXAMPLE 1, it can be verified that the oilless fixability with the PFA tube fixing roll is good; the minimum fixing temperature (this temperature is determined on the image contamination resulting from the cloth rubbing of the image) is 100° C. or higher; and at this temperature, the image exhibits a sufficient fixability, and the transfer paper is peeled off with no resistance. The surface gloss of the image at a fixing temperature of 150° C. is as good as 68%; the developability and the transferability are both good; and a high-quality image with no image defects is provided. However, at a fixing temperature of 190° C. or higher, occurrence of a slight hot offset is observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (6) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of a slight amount of aggregates is observed, but the amount is in the range which causes no practical problem (the stability is evaluated “◯” (the symbol will be described later)).

### Example 6

{Toner 6}

The toner particles are obtained in the same manner as that in EXAMPLE 2, except that, in EXAMPLE 2, according to the amounts of compounding as given in Table 1, the dispersion of fine resin particles (2) is changed into the dispersion of fine resin particles (7).

With these toner particles, the cumulative volume-average particle diameter D₅₀ is 5.80 μm, and the volume-average particle size distribution index GSDv is 1.41. In addition, the shape factor SF1 is 137, indicating a potato-like shape.

By using these toner particles to obtain an externally additive toner in the same manner as that in EXAMPLE 1; further preparing a developer; and examining the fixability of the toner in the same manner as that in EXAMPLE 1, it can be verified that the oilless fixability with the PFA tube fixing roll is good; the minimum fixing temperature (this temperature is determined on the image contamination resulting from the cloth rubbing of the image) is 120° C. or higher; and at this temperature, the image exhibits a sufficient fixability, but the transfer paper is slightly poorly peeled off. In addition, at a fixing temperature of 170° C. or above, occurrence of a slight hot offset is observed. Further, occurrence of coarse powder is observed in the toner, and the image has defects, such as white spot and the like.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (7) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of an aggregate is utterly not observed, and thus the dispersion is in the stable state (the stability is evaluated “\textcircled{∘}” (the symbol will be described later)).

### Example 7

{Toner 7}

The toner particles are obtained in the same manner as that in EXAMPLE 2, except that, in EXAMPLE 2, according to the amounts of compounding as given in Table 1, the dispersion of fine resin particles (2) is changed into the dispersion of fine resin particles (8).

With these toner particles, the cumulative volume-average particle diameter D₅₀ is 5.95 μm, and the volume-average particle size distribution index GSDv is 1.29. In addition, the shape factor SF1 is 119, indicating a spherical shape.

By using these toner particles to obtain an externally additive toner in the same manner as that in EXAMPLE 1; further preparing a developer; and examining the fixability of the toner in the same manner as that in EXAMPLE 1, it can be verified that the minimum fixing temperature (this temperature is determined on the image contamination resulting from the cloth rubbing of the image) is 90° C. or higher, and at this temperature, the image exhibits a sufficient fixability, but the transfer paper is slightly poorly peeled off. In addition, at a fixing temperature of 130° C. or above, occurrence of a slight hot offset is observed.

In addition, when the toner image strength is examined by fully folding a solid image fixed on a J-Paper manufactured by Fuji Xerox Co., Ltd., then opening the paper, and rubbing the folded portion with a waste cloth, which is then followed by checking for degree of occurrence of a white line due to the exposure of the substrate paper, the white line is utterly not conspicuous, and thus there is no problem about the toner image strength.

In addition, when, before preparation of the toner, the stability of the dispersion of fine resin particles (8) used is examined by the method which weighs off 100 g of the dispersion of fine resin particles into a 300-ml stainless steel beaker, and shearing-homogenizes it in the beaker by use of an IKA Ultra-Tarrax T50 for 1 minute, which is followed by filtering the dispersion of fine resin particles with a 77-μm nylon mesh to observe whether an aggregation is caused or not, (the shearing-homogenization method), occurrence of an aggregate is utterly not observed, and thus the dispersion is in the stable state (the stability is evaluated “\textcircled{∘}” (the symbol will be described later)).

### Comparative Example 1

{Toner Control 1}

(Preparation of Dispersion of Fine Resin Particles (10))

Into a three-necked flask, 80 parts of 1,9-nonandiol and 115.2 parts of 1,10-dodecanedioic acid are well mixed at 90° C., and cooled to room temperature, then to the solution, 2.0 parts of scandium trifluoromethanesulfonate [Sc(OSO₂CF₃)₃] is added as a catalyst, and dissolved.

This mixture is thrown into 1377 parts of deionized water in which 11 parts of sodium dodecylbenzensulfonate, and 4 parts of scandium trisdodecylsulfate are dissolved, and predispersed by ultrasonic wave, which is then further emulsifying-dispersed at 80° C. with an ultra-high pressure homogenizer (Nanomizer: manufactured by YOSHIDA KIKAI Co., Ltd.) to provide an emulsified product having a volume-average particle diameter of 0.5 μm.

This emulsified product is thrown into a 3-L pressurized reactor equipped with a stirrer, and polymerization is carried out at 100° C. for 12 hr in a nitrogen atmosphere to obtain a dispersion of fine resin particles. Examination of the reaction product for stability as in EXAMPLES shows that it maintains a stable emulsified state. But, with the reaction product, the median diameter is 0.55 μm; the weight-average molecular weight is 3500; the number-average molecular weight is 900; the crystal melting point is 65° C.; and the coefficient of variation of the particle size distribution is 52%; thus no fine resin particles having a molecular weight which is high enough to allow practical use as a resin dispersion for toner can be obtained. In addition, checking for stability of the dispersion in the same manner as described above revealed that a large amount of aggregates was produced (the stability of the dispersion is evaluated “x” (the symbol will be described later)).

The results of these EXAMPLES and the COMPARATIVE EXAMPLE are collectively given in Table 1. In the table, the evaluation criteria for stability of a dispersion of fine resin particles are: “\textcircled{∘}”, which means that no aggregation occurs; “◯”, which means that a slight amount of aggregates occurs, but there is no problem; “Δ”, which means that some amount of aggregates occurs; and “x”, which means that a large amount of aggregates are produced. For image quality, the evaluation criteria are: “◯”, which means that the image quality is very good; “Δ”, which means that it is good; and “x”, which means that there occurs an image defect. For image strength, the evaluation criteria are: “◯”, which means that the image strength is good; “Δ”, which means that there is no problem of practical use; and “X”, which means that there occurs a defect.

TABLE 1

| | EX. 1 | EX. 2 | EX. 3 | EX. 4 | EX. 5 | EX. 6 | EX. 7 | COMP. EX. |
|---|---|---|---|---|---|---|---|---|
| Disp. of fine resin | (1) 233 | (2) 262 | (3) 246 | (5) 233 | (6) 420 | (7) 233 | (8) 280 | (10) |
| particles (p. by w.) | (9) 50 | (9) 100 | (4) 300 | (9) 100 | | (9) 100 | (9) 100 | |
| Disp. of coloring agent | (1) 40 | (2) 40 | (3) 40 | (1) 40 | (1) 40 | (2) 40 | (2) 40 | — |
| particles (p. by w.) | | | | | | | | |
| Disp. of release agent | 40 | 40 | 40 | 40 | 40 | 40 | 40 | — |
| particles (p. by w.) | | | | | | | | |
| Polycondensed resin | (1) 7500 | (2) 5800 | (3) 8200 | (5) 11200 | (6) 5500 | (7) 4300 | (8) 7100 | (10) 3500 |
| weight-average mol. w. | | | (4) 6200 | | | | | |
| Polycondensed resin | (1) 2200 | (2) 2200 | (3) 2700 | (5) 3500 | (6) 2100 | (7) 1700 | (8) 2500 | (10) 900 |
| number-average mol. w. | | | (4) 2500 | | | | | |
| Polycondensed resin | (1) 0.65 | (2) 0.35 | (3) 0.18 | (5) 0.27 | (5) 1.40 | (7) 2.30 | (8) 0.16 | (10) 0.55 |
| median diameter,^{μ}m | | | (4) 0.65 | | | | | |
| Crystalline resin | (1) 70 | (2) 69 | (3) 56 | (5) 71 | (6) 68 | (7) 68 | (8) 48 | (10) 65 |
| melting point, ° C. | | | | | | | | |
| Non-crystalline resin | (9) 53.5 | (9) 53.5 | (4) 54 | (9) 53.5 | — | (9) 53.5 | (9) 53.5 | — |
| glass trans. p., ° C. | | | | | | | | |
| Stability of resin | ⊚ | ⊚ | ⊚ | ⊚ | ◯ | ⊚ | ⊚ | X |
| particle dispersion | | | | | | | | |
| Toner particle diameter, ^{μ}m | 4.50 | 4.70 | 4.10 | 3.80 | 3.70 | 5.80 | 5.95 | — |
| Toner shape factor | 132 | 122 | 117 | 133 | 121 | 137 | 119 | — |
| Minimum fixing | 120 | 110 | 105 | 110 | 100 | 120 | 90 | — |
| temperature, ° C. | | | | | | | | |
| Hot offset temperature, | 200 or | 200 or | 200 or | 200 or | 190 | 170 | 130 | — |
| ° C. | above | above | above | above | | | | |
| Image quality | ◯ | ◯ | ◯ | ◯ | ◯ | Δ | Δ | — |
| Image strength | ◯ | ◯ | ◯ | ◯ | ◯ | Δ | ◯ | — |

The number in parentheses at left of a numerical value denotes the number of the applicable dispersion of fine resin particles.

From the above results, it can be seen that, in the present EXAMPLES, where a strong acid salt is used as a polycondensation promoter together with the polycondensation catalyst, dispersions of fine resin particles having a high molecular weight and a sharp particle size distribution can be obtained. Moreover, it can also be seen that the polycondensation proceeds in a short time period.

In addition, it can also be made out that the dispersion of fine resin particles obtained is stable in emulsification/dispersion state. It can also be understood that, by using an atomized strong acid salt as a polycondensation promoter, a good catalytic function is achieved. Further, it can be comprehended that, by controlling the median diameter of the particles to within a prescribed range, the emulsification/dispersion stability of the dispersion solution is improved.

In addition, the toner manufactured by using the dispersion of fine resin particles of the present invention provides a high molecular weight, thus having sufficient image strength with a good fixability, and being free from occurrence of hot offset.

Contrarily to this, it can be known that, in the COMPARATIVE EXAMPLE, not only a molecular weight which is high enough to allow manufacture of the toner cannot be obtained, but also the particle size distribution is degraded.

As described above, according to the present invention, a polycondensation promoter with which a dispersion of fine resin particles having a high molecular weight and a sharp particle size distribution and yet being stable in emulsification/dispersion state can be manufactured in an aqueous medium can be provided.

In addition, according to the present invention, a method for manufacturing dispersion of fine resin particles that, by utilizing this polycondensation promoter, can manufacture a dispersion of fine resin particles having a high molecular weight and a sharp particle size distribution and yet being stable in emulsification/dispersion state in an aqueous medium, and a dispersion of fine resin particles obtained thereby can be provided.

In addition, according to the present invention, a method for manufacturing electrostatic charge image developing toner that, by utilizing this method for manufacturing dispersion of fine resin particles, can manufacture a toner sufficiently meeting the toner characteristics, and an electrostatic charge image developing toner obtained thereby can be provided.

The polycondensation promoter of the present invention features that it comprises a strong acid salt.

With respect to the polycondensation promoter of the present invention, it is preferable that the strong acid salt be of at least one type selected from zeolite, sulfated zirconia, zirconia tungstate, tungstosilisic acid, zirconia molybdate, and heteropoly acid. In addition, it is preferable that the polycondensation promoter of the present invention be used for formation of a polyester. The polycondensation promoter of the present invention is preferably a promoter wherein at least one polycondensation catalyst selected from surfactant-type catalysts, hydrolysis enzymes, and rare-earth containing catalysts provides the main catalyst.

In addition, the method for manufacturing of dispersion of fine resin particles of the present invention comprises a step of emulsifying or dispersing a polycondensable monomer in an aqueous medium; and a polycondensation step for polycondensing the polycondensable monomer in an aqueous medium; wherein, at the polycondensation step, a polycondensation catalyst, and a polycondensation promoter comprising a strong acid salt are used for carrying out a polycondensation reaction. The strong acid salt is preferably of at least one type selected from zeolite, sulfated zirconia, zirconia tungstate, tungstosilisic acid, zirconia molybdate, and heteropoly acid.

With respect to the method for manufacturing of dispersion of fine resin particles of the present invention, it is preferable that the strong acid salt exist as a solid in the polycondensable monomer. Further, the strong acid salt as the polycondensation promoter is preferably contained in the polycondensable monomer, and exists as a solid in the polycondensable monomer in mixing with the polycondensable monomer.

With respect to the method for manufacturing of dispersion of fine resin particles of the present invention, it is preferable that the polycondensation catalyst be at least one selected from surfactant-type catalysts, hydrolysis enzymes, and rare-earth containing catalysts.

With respect to the method for manufacturing of dispersion of fine resin particles of the present invention, it is preferable that the polycondensable monomer contain a multivalent carboxylic acid and a polyol. In addition, the fine resin particles preferably have a melting point of 50° C. to below 120° C. Further, the fine resin particles preferably have a glass transition point of 50° C. to below 80° C.

In addition, the dispersion of fine resin particles of the present invention is a dispersion of fine resin particles with which the fine resin particles are dispersed into an aqueous medium, and features that the fine resin particles contain a polycondensation promoter (the polycondensation promoter of the present invention) comprising a strong acid salt. The fine resin particles are capable of being formed by emulsifying or dispersing a polycondensable monomer in an aqueous medium for polycondensation.

With respect to the dispersion of fine resin particles of the present invention, it is preferable that the fine resin particles be crystalline, and the crystal melting point thereof be 50° C. to below 120° C. In addition, it is preferable that the fine resin particles be non-crystalline, and the glass transition point thereof be 50° C. to below 80° C. In addition, the strong acid salt in the dispersion of fine resin particles of the present invention is preferably of at least one type selected from zeolite, sulfated zirconia, zirconia tungstate, tungstosilisic acid, zirconia molybdate, and heteropoly acid.

With respect to the dispersion of fine resin particles of the present invention, it is preferable that the fine resin particles contain a polyester resin. In addition, the median diameter of the fine resin particles is preferably 0.05 μm to 2.0 μm.

The dispersion of fine resin particles of the present invention is preferably for electrostatic charge image developing toner.

The method for manufacturing of electrostatic charge image developing toner of the present invention features that it uses the dispersion of fine resin particles of the present invention (a dispersion of fine resin particles dispersing fine resin particles containing a polycondensation promoter comprising a strong acid salt in an aqueous medium), aggregates the fine resin particles in the dispersion, and then heats them for fusion. In this case, it is preferable that the strong acid salt be of at least one type selected from zeolite, sulfated zirconia, zirconia tungstate, tungstosilisic acid, zirconia molybdate, and heteropoly acid.

The electrostatic charge image developing toner of the present invention contains a polycondensation promoter (the polycondensation promoter of the present invention) comprising a strong acid salt. The strong acid salt is preferably of at least one type selected from zeolite, sulfated zirconia, zirconia tungstate, tungstosilisic acid, zirconia molybdate, and heteropoly acid. In addition, with respect to the electrostatic charge image developing toner of the present invention, it is preferable that the toner be obtained by using a dispersion of fine resin particles dispersing fine resin particles containing a strong acid salt in an aqueous medium, aggregating the fine resin particles in the dispersion, and then heating them for fusion.

What is claimed is:

1. A polycondensation promoter comprising a strong acid salt.

2. The polycondensation promoter of claim 1, wherein the strong acid salt is of at least one selected from zeolite, sulfated zirconia, zirconia tungstate, tungstosilisic acid, zirconia molybdate, and heteropoly acid.

3. The polycondensation promoter of claim 1 for polycondensing a polyester.

4. The polycondensation promoter of claim 1 that is a promoter wherein at least one polycondensation catalyst selected from surfactant-type catalysts, hydrolysis enzymes, and rare-earth containing catalysts provides the main catalyst.

5. A method for manufacturing a dispersion of fine resin particles comprising emulsifying or dispersing a polycondensable monomer in an aqueous medium; and polycondensing the polycondensable monomer in the aqueous medium; wherein,
a polycondensation catalyst and a polycondensation promoter comprising a strong acid salt are used for polycondensing the polycondensable monomer.

6. The method for manufacturing a dispersion of fine resin particles of claim 5, wherein the strong acid salt is of at least one type selected from zeolite, sulfated zirconia, zirconia tungstate, tungstosilisic acid, zirconia molybdate, and heteropoly acid.

7. The method for manufacturing a dispersion of fine resin particles of claim 5, wherein the strong acid salt exists as a solid in the polycondensable monomer.

8. The method for manufacturing a dispersion of fine resin particles of claim 5, wherein the polycondensation catalyst is at least one selected from surfactant-type catalysts, hydrolysis enzymes, and rare-earth containing catalysts.

9. The method for manufacturing a dispersion of fine resin particles of claim 5, wherein the polycondensable monomer contains a multivalent carboxylic acid and a polyol.

10. The method for manufacturing a dispersion of fine resin particles of claim 5, wherein the fine resin particles have a melting point of from about 50° C. to about 120° C.

11. The method for manufacturing a dispersion of fine resin particles of claim 5, wherein the fine resin particles have a glass transition point of from about 50° C. to about 80° C.

12. A dispersion of fine resin particles in which the fine resin particles are dispersed in an aqueous medium, wherein the fine resin particles contain a polycondensation promoter comprising a strong acid salt.

13. The dispersion of fine resin particles of claim 12, wherein the fine resin particles are crystalline, and the crystal melting point of the fine resin particles is from about 50° C. to about 120° C.

14. The dispersion of fine resin particles of claim 12, wherein the fine resin particles are non-crystalline, and the glass transition point of the fine resin particles is from about 50° C. to about 80° C.

15. The dispersion of fine resin particles of claim 12, wherein the strong acid salt is at least one selected from zeolite, sulfated zirconia, zirconia tungstate, tungstosilisic acid, zirconia molybdate, and heteropoly acid.

16. The dispersion of fine resin particles of claim 12, wherein the median diameter of the fine resin particles is from about 0.05 μm to about 2.0 μm.

17. The dispersion of fine resin particles of claim 12, wherein the fine resin particles are used for electrostatic charge image developing toner.

18. A method for manufacturing an electrostatic charge image developing toner, comprising aggregating fine resine particles in a dispersion of the fine resine particles in an aqueous medium, the fine resin particles containing a polycondensation promoter comprising a strong acid salt, heating and fusing the aggregated fine resin particles.

19. The method for manufacturing an electrostatic charge image developing toner of claim 18, wherein the strong acid salt is at least one selected from zeolite, sulfated zirconia, zirconia tungstate, tungstosilisic acid, zirconia molybdate, and heteropoly acid.

20. An electrostatic charge image developing toner having a strong acid salt.

21. The electrostatic charge image developing toner of claim 20, wherein the strong acid salt is at least one selected from zeolite, sulfated zirconia, zirconia tungstate, tungstosilisic acid, zirconia molybdate, and heteropoly acid.

22. The electrostatic charge image developing toner of claim 20, wherein the toner is obtained by comprising aggregating fine resin particles in a dispersion of the fine resin particles in an aqueous medium, the fine resin particles containing a polycondensation promoter comprising a strong acid salt, heating and fusing the aggregated fine resin particles.
